(19) United States
(12) Patent Application Publication
(10) Pub. No.: US 2018/0023321 A1
(43) Pub. Date: Jan. 25, 2018

(54) CABINET LOCK FOR MERCHANDISE SECURITY

(71) Applicant: InVue Security Products Inc., Charlotte, NC (US)

(72) Inventors: A. Reneau Van Landingham, JR., Gastonia, NC (US); Karen B. Bomber, Lake Wylie, SC (US)

(21) Appl. No.: 15/653,988

(22) Filed: Jul. 19, 2017

Related U.S. Application Data
(60) Provisional application No. 62/416,225, filed on Nov. 2, 2016.
(60) Provisional application No. 62/364,641, filed on Jul. 20, 2016.

(51) Int. Cl. E05B 47/02; E05B 65/08; E05B 63/18

(52) U.S. Cl. CPC E05B 47/02; E05B 47/026; E05B 63/185; E05B 65/0864; E05B 17/00

(57) ABSTRACT

Embodiments of the invention are directed to merchandise security devices, systems, and methods for protecting an item of merchandise from theft. For example, a merchandise security device may include a lock configured to be secured to a movable structure and a strike plate configured to be secured to a fixed support structure. The movable structure is configured to move along a path into engagement with the fixed support structure to secure the item of merchandise therein in a locked state and to move out of engagement with the fixed support structure for removal of the item of merchandise in an unlocked state. The lock is configured to engage the strike plate in the locked state and to disengage the strike plate in the unlocked state, and the lock is configured to engage the strike plate along the same path as the movable structure.

### CROSS REFERENCE TO RELATED APPLICATIONS

This application claims the benefit to priority of U.S. Provisional Patent Application No. 62/416,225 filed on Nov. 2, 2016 and U.S. Provisional Patent Application No. 62/364,641 filed on Jul. 20, 2016, the entire disclosures of each of which are incorporated herein by reference.

### FIELD OF THE INVENTION

Embodiments of the invention relate generally to security devices, systems, and methods for protecting an item of merchandise from theft. More particularly, embodiments of the invention relate to security devices, systems and methods including self-locking functionality for merchandise security.

### BACKGROUND OF THE INVENTION

It is common practice for retailers to store and/or display relatively expensive items of merchandise on or within a merchandise security device, such as a security display (e.g. alarming stand), security fixture (e.g. locking hook, shelf, cabinet, etc.) or security packaging (e.g. merchandise keeper). Regardless, the security device stores and/or displays an item of merchandise so that a potential purchaser may view, and in some instances, interact with the item before making a decision whether to purchase the item. At the same time, the item is secured on or within the merchandise security device so as to prevent, or at least deter, theft of the item. The value of the item, however, may make it an attractive target for a shoplifter despite the presence of a merchandise security device. A determined shoplifter may attempt to detach the item from the security display or to remove the item from the security fixture or from within the security packaging. Alternatively, the shoplifter may attempt to remove all or a portion of the security device from the display area along with the item of merchandise.

In the case of a security fixture, and in particular a merchandise display cabinet or drawer, the merchandise security device is oftentimes locked with a lock to prevent merchandise from being removed from the cabinet or drawer without the assistance of an authorized person, such as a sales associate.

### BRIEF SUMMARY

Embodiments of the present invention are directed towards merchandise security devices, systems, and methods for protecting an item of merchandise from theft. In one example, a merchandise security device comprises a lock configured to be secured to one of a movable structure or a fixed support structure and a strike plate configured to be secured to one of the movable structure of the fixed support structure, opposite that of the lock. The movable structure is configured to move along a path into engagement with the fixed support structure to secure the item of merchandise therein in a locked state and to move out of engagement with the fixed support structure for removal of the item of merchandise in an unlocked state. The lock is configured to engage the strike plate in the locked state and to disengage the strike plate in the unlocked state, and the lock is configured to engage the strike plate along the same path as the movable structure.

In another example, a merchandise security system comprises a merchandise fixture comprising a movable structure and a fixed support structure, as well as a lock configured to be secured to the movable structure and a strike plate configured to be secured to the fixed support structure. The movable structure is configured to move along a path into engagement with the fixed support structure to secure the item of merchandise therein in a locked state and to move out of engagement with the fixed support structure for removal of the item of merchandise in an unlocked state. The lock is configured to engage the strike plate in the locked state and to disengage the strike plate in the unlocked state, and the lock is configured to engage the strike plate along the same path as the movable structure.

In another example, a method comprises securing a strike plate to an outer surface of a merchandise fixture without removing any portion of the outer surface for receiving the strike plate and attaching a lock to the merchandise fixture, the lock configured to engage the strike plate in a locked state and to disengage the strike plate in an unlocked state.

In another example, a merchandise security device comprises a lock configured to be secured to one of a movable structure or a fixed support structure and a strike plate configured to be secured to an outer surface of one of the movable structure or the fixed support structure, opposite that of the lock, without removing any portion of the outer surface for receiving the strike plate. The lock is configured to engage the strike plate in the locked state and to disengage the strike plate in the unlocked state.

In another example, a method comprises securing a strike plate to one of a movable structure or a fixed support structure, the movable structure configured to move along a path into engagement with the fixed support structure to secure an item of merchandise therein in a locked state and to move out of engagement with the fixed support structure for removal of the item of merchandise in an unlocked state. The method further comprises attaching a lock to one of the movable structure of the fixed support structure, opposite that of the strike plate, the lock configured to engage the strike plate in a locked state and to disengage the strike plate in an unlocked state, the lock configured to engage the strike plate along the same path as the movable structure.

### BRIEF DESCRIPTION OF THE DRAWINGS

FIG. 1 is a perspective view of a merchandise security system according to one embodiment of the present invention.

FIG. 2 is a perspective view of the electronic lock shown in FIG. 1 in a locked state.

FIG. 3 is a side view of the electronic lock shown in FIG. 1 in a locked state.

FIG. 4 is a top view of the electronic lock shown in FIG. 1 in a locked state.

FIG. 5 is a bottom view of the electronic lock shown in FIG. 1.

FIG. 6 is a perspective view of the strike plate shown in FIG. 1.

FIG. 7 is a schematic of an electronic lock and an electronic device according to one embodiment.

FIG. 8 is a perspective view of a merchandise security system according to one embodiment of the present invention.

FIG. 9 is a perspective view of an electronic lock and a strike plate according to one embodiment of the present invention.

FIG. 10 is a bottom view of the electronic lock and strike plate shown in FIG. 9.

FIG. 11 is a side view of the electronic lock (shown partially transparent) and strike plate shown in FIG. 9.

FIG. 12 is an end perspective view of the electronic lock (shown partially transparent) and strike plate shown in FIG. 9.

FIG. 13 is another perspective view of the electronic lock (shown partially transparent) and strike plate shown in FIG. 9.

FIG. 14 is a perspective view of the strike plate shown in FIG. 9.

FIG. 15 illustrates various views of installing an electronic lock to a door according to one embodiment of the present invention.

### DETAILED DESCRIPTION OF EMBODIMENTS OF THE INVENTION

Referring now to the accompanying drawing figures wherein like reference numerals denote like elements throughout the various views, one or more embodiments of a merchandise security device and system are shown. A merchandise security device and system according to embodiments of the invention is operable for use with a merchandise fixture that stores and/or displays merchandise, for example, in a retail store. In the embodiments shown and described herein, a merchandise security device 10 includes an electronic lock 12 and an electronic device 50 configured for at least unlocking a merchandise fixture 18.

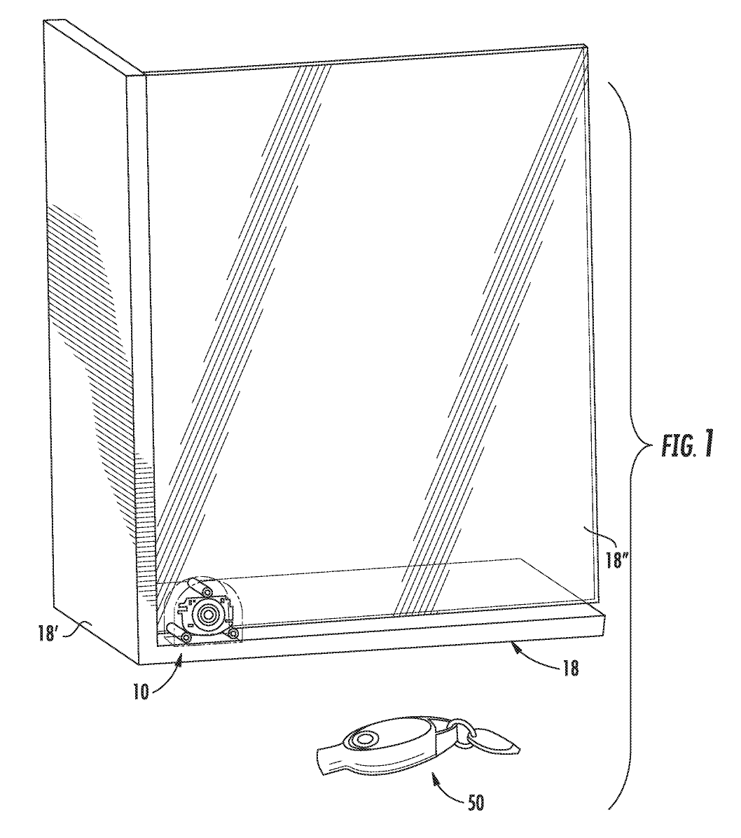

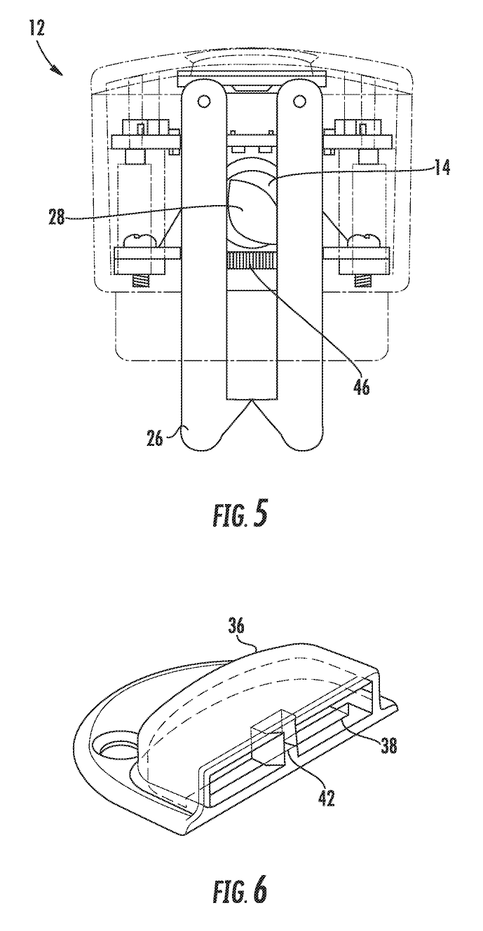

An embodiment of a merchandise security device 10 according to the invention is illustrated in FIGS. 1-6. The merchandise security device 10 depicted therein is operable for use with a merchandise fixture 18, for example, a merchandise cabinet adapted for storing and protecting items of merchandise disposed within the cabinet. The merchandise fixture 18 may include a table, cabinet, desk, or other fixed support structure 18′ in operable engagement with a movable structure 18″ (e.g., a door) that allows the movable structure to be moved into and out of engagement with the fixed support structure. The door 18″ may include a handle for allowing a user to pull the door away from the support structure 18′ to access to an item of merchandise, and to move the door″ towards the support structure for preventing access to an item of merchandise when the door is in a closed and locked configuration. In other cases, a portion of the electronic lock 12 may protrude outwardly from the door 18″ and be configured to be used as a handle. Although the illustrated embodiments are discussed for use with a cabinet, it should be noted that the invention is applicable to any number of merchandise fixtures, such as merchandise display drawers, doors, or the like that utilize a lock.

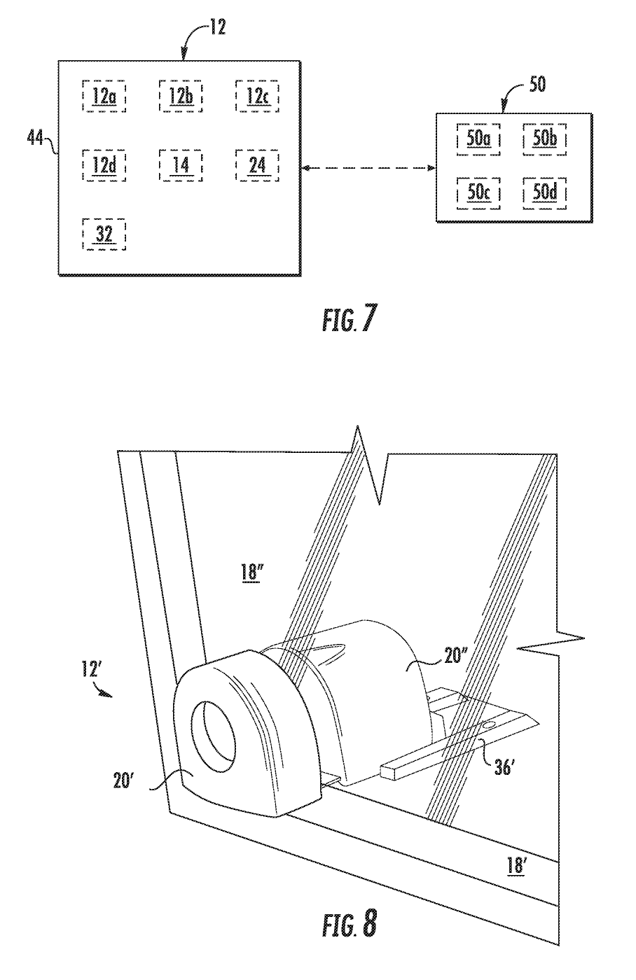

In one embodiment, the electronic lock 12 is configured to communicate with an electronic device 50. The electronic device 50 may be configured to control the electronic lock 12, such as to lock and/or unlock the lock. In one example, the electronic device 50 is an electronic key configured to transfer power to the electronic lock 12. In some cases, the electronic device 50 is configured to function as a non-mechanical, contactless key for locking and/or unlocking the electronic lock 12. The electronic device 50 may include various components, such as, for example, a housing, a controller or processor 50a disposed within the housing, a display disposed on the housing and coupled to the processor, a power source 50b, wireless communication functionality 50c, an internal memory 50d, a SIM card and/or SM card, a camera, a speaker, and/or a user interface (see, e.g., FIG. 7). The power source 50b may be a multiple-use internal power source, such as a conventional capacitor or rechargeable battery.

The electronic lock 12 may include a housing 20 that is configured to contain a variety of components, as explained in further detail below (a portion of the housing 20 being transparent for purposes of illustration). The housing 20 may be secured to the door 18″ using any desired technique, such as fasteners and/or adhesives. Where the door 18″ is glass, an adhesive may be used. As shown in FIGS. 1-4, for example, the housing 20 is fastened to an outer surface of the door 18″. A portion 40 of the housing 20 may extend underneath a bottom surface of the door 18″ as shown in FIG. 3. This portion 40 may be configured to prevent or limit access to the actuator 26 when the door 18″ is in a closed position. As such, the portion 40 may function as an “anti-picking” feature.

The electronic lock 12 may include a transfer port 22. The transfer port 22 may facilitate communication between the electronic device 50 and the electronic lock 12. In some cases, the communication between the electronic lock 12 and the electronic device 50 is wireless, although wired communication may be used in other cases. Moreover, the housing 20 may contain a controller or processor 12a that is in communication with a lock mechanism 24. The processor 12a may be configured to actuate the lock mechanism 24 in response to receiving electrical power from the electronic device 50.

The electronic lock 12 may also contain an internal source of electrical power 12b, such as one or more capacitors, batteries, or the like. However, in other embodiments, the electronic lock 12 may not include an internal power source, and as such, may be “electrically passive”. In this case, the electronic device 50 may contain an internal source of electrical power 50b, such as a conventional extended-life or rechargeable battery, capacitor or the like, that is configured to transfer electrical power to the electronic lock 12 for at least the purpose of unlocking the lock mechanism 24. The electronic device 50 may transfer electrical power to the electronic lock 12 in any suitable manner, such as by electrical contacts, acoustical transmission (e.g. RF signals), or magnetic induction. In this regard, the electronic lock 12 and the electronic device 50 may each contain inductive coils for transferring power from the electronic device to the electronic lock. In one embodiment, electrical power transferred by the electronic device 50 is configured to charge an internal power source 12b of the electronic lock 12. For example, the electronic lock 12 may include one or more capacitors that are configured to be charged in response to receiving electrical power from the electronic device 50. The capacitor(s) may be used to perform one or more functions as will be described in further detail below. Thus, the electronic lock 12 may be configured to harvest energy provided by the electronic device 50.

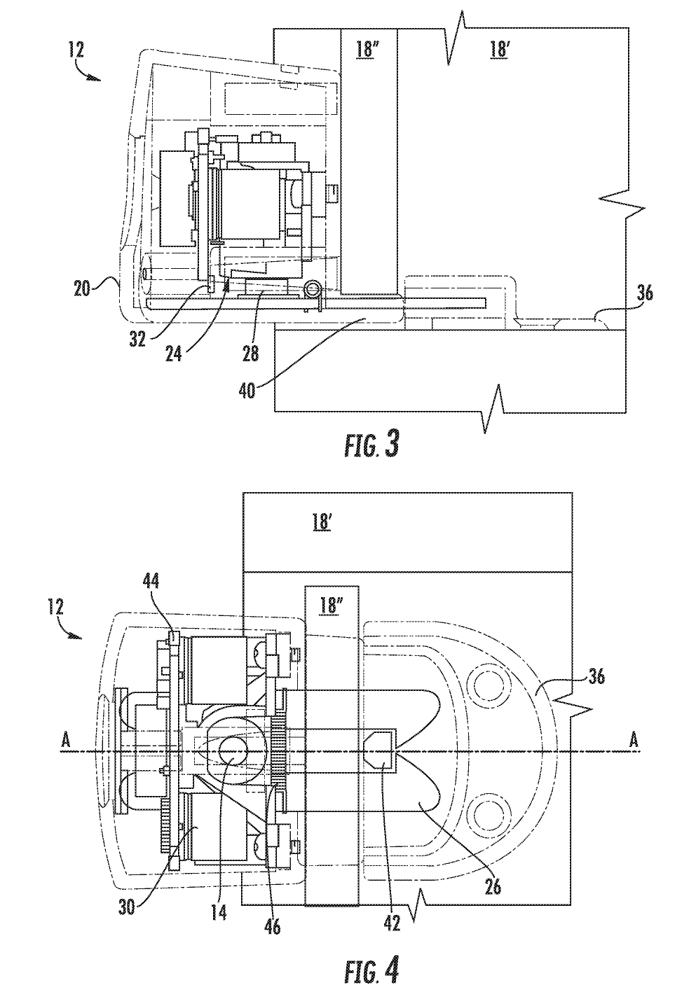

As previously mentioned, the electronic lock 12 may include a lock mechanism 24 configured to move between locked and unlocked configurations. In the illustrated embodiment, the lock mechanism 24 is a mechanical lock including one or more actuators 26 that are configured to move between an engaged position and a disengaged position. As shown in FIGS. 4-5, a pair of actuators 26 may be provided. Each actuator 26 may be configured to pivot between the engaged and disengaged positions. For instance, one end of each actuator 26 may be pivotably mounted within the housing 20. In the engaged position (e.g., FIGS. 4-5), the actuators 26 may extend generally parallel to one another. The actuators 26 may be longitudinal members in some embodiments. In some cases, the ends of the actuators 26 are configured to extend outwardly of the housing 20 at least in the locked state, but may also extend outwardly from the housing in both the locked and unlocked states.

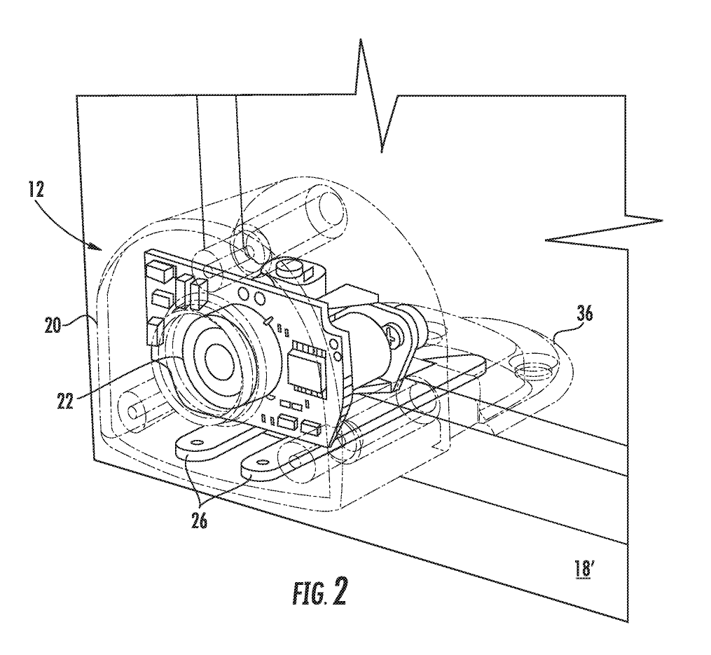

However, it is understood that the lock mechanism 24 may be any suitable mechanism that is configured to move between locked and unlocked states or engaged or disengaged positions, such as a plunger, cam, or the like. The electronic lock 12 may be equipped with an electric motor, DC stepper motor, solenoid, or the like, that is in communication with a processor and powered by an internal power source for actuating the lock mechanism 24. In one example, power provided by the electronic device 50 may be used to power a motor 14 for actuating the lock mechanism 24 (see, e.g., FIG. 4). FIGS. 2-5 (a portion of the housing 20 being transparent for purposes of illustration) show that the electronic lock 12 may include a circuit board 44 for electrical connection to various electrical components, such as the motor 14, power source 12b, processor 12a, etc.

The actuator 26 is configured to operably engage a strike plate 36 in a locked state. The strike plate 36 may include one or more openings 38 defined therein for receiving a portion of the actuator 26. In the case where a pair of actuators 26 are employed, the strike plate 36 may include a pair of openings or an opening large enough to receive at least an end of both actuators. The strike plate 36 may include an engagement member 42 that is configured to engage each actuator 26. For example, FIG. 4 shows that the end of each actuator 26 may be configured to extend within the opening 38 and engage the engagement member 42 on opposite sides thereof. In this example, the ends of each actuator 26 are hook shaped and are configured to extend at least partially around the engagement member 42.

The strike plate 36 may be configured to be secured to the merchandise fixture 18 using a variety of techniques, such as via one or more fasteners and/or adhesive. In the case where the fixed support structure 18′ is formed of glass, an adhesive may be used. In one embodiment, the strike plate 36 may be secured directly to an outer surface of the merchandise fixture 18 without the need for machining, milling, or otherwise removing a portion of the outer surface of the merchandise fixture to receive the strike plate. Thus, the strike plate 36 may be secured directly to an outer surface of the merchandise fixture, and in some cases, directly to the fixed support structure 18′.

In one embodiment, the electronic lock 12 is configured to engage the strike plate 36 along the same path as that the door 18″ or movable structure moves. For instance, FIG. 4 shows path “A”. The door 18″ or movable structure is configured to move along the path A between open and closed positions, wherein the path may be linear or arcuate. For example, where the door 18″ or movable structure is configured to pivot relative to the fixed support structure 18′, the door or movable structure may follow an arcuate path A. The electronic lock 12 is carried by the door 18″ or movable structure and is configured to follow the same path A. Moreover, the actuators 26 are configured to engage the strike plate 36 along the same path A. Thus, unlike conventional locks that engage a strike plate perpendicular to a path that a door moves, in one embodiment, the electronic lock 12 is capable of engaging the strike plate 36 along the same path. This directional arrangement may allow for more flexibility in the location where the electronic lock 12 and strike plate 36 may be mounted. It is understood that in some embodiments, the location of the electronic lock 12 and strike plate 36 may be reversed, e.g., the lock secured to the fixed support structure 18′ and the strike plate secured to the movable structure 18″.

FIGS. 3-5 show an embodiment of a lock mechanism 24 whereby a motor 14 is configured to rotate a camming mechanism 28. In some cases, rotation of the camming mechanism 28 results in actuation of the actuator 26. FIG. 5 shows the lock mechanism 24 in a locked state whereby each actuator 26 extends generally parallel to one another. In an unlocked state, the actuators 26 are forced away from one another. In the unlocked state, the camming mechanism 28 is in engagement with each of the actuators 26. Thus, engagement of the camming mechanism 28 with the actuators 26 forces the actuators to a disengaged position. For example, the camming mechanism 28 may force the actuators 26 to pivot away from one another thereby disengaging the engagement member 42, which allows the door 18″ to be moved to an open position. FIG. 3 shows that the lock 12 may also include one or more switches 32. The switch 32 may be actuated in response to engagement with the camming mechanism 28 which results in deactivation of the motor 14. For example, once the actuator 26 is moved to locked state or an unlocked state, the motor 14 is temporarily deactivated. Deactivation of the motor 14 may ensure that the camming mechanism 28 is maintained in a desired position.

Advantageously, the lock mechanism 24 may be configured to automatically move from an unlocked state to a locked state. For example, the actuator 26 may be biased towards a locked state. In some cases, the actuators 26 are biased towards one another via a biasing element 44 (e.g., a spring). Thus, as the door 18″ is moved to a closed position relative to the fixed support structure 18′, the actuators 26 may be configured to be biased to allow for engagement with the engagement member 42.

As noted above, the electronic device 50 may be configured to transfer power to the electronic lock 12 for operating the lock mechanism 24, which may be used to charge one or more capacitors 30. Power stored by the capacitor(s) 30 may be used to activate the motor 14 to move the actuators 26 from the unlocked state to a locked state. The processor 12a may be configured to activate the motor 14 after a predetermined period time after the lock mechanism 24 has been unlocked (e.g., about 1 second, about 2 seconds, about 3 seconds, about 4 seconds, about 5 seconds, etc.). Therefore, the lock mechanism 24 is configured to self lock after remaining in an unlocked state for a predetermined period of time. In use, when the lock mechanism 24 is unlocked with the electronic device 50 and the door 18″ is opened, the lock mechanism will move to the locked state after a predetermined period of time. As noted above, the lock mechanism 24 may include a biasing element 46 (e.g., a spring) and be configured to automatically lock when the door 18″ is moved to a closed position. For instance, the actuators 26 may be biased towards the locked state.

In some embodiments, the electronic lock 12 may include a plurality of internal power sources 12b. As discussed above, the electronic lock 12 may include a capacitor 30 for automatically actuating the lock mechanism 24 from an unlocked state to a locked state. For instance, a power source 12b may be used to activate a motor 14, while the same or an additional power source may be employed for the processor 12a. The lock mechanism 24 may include an internal power source 12b for performing other functions, such as for auditing of the electronic lock 12 and/or the electronic device 50. For example, the electronic lock 12 may be configured to store in memory 12c information relating to the electronic device 50, the date and/or time of the unlocking and/or locking event, the number of unlocking and/or locking events, etc. In one example, the lock mechanism 24 may be configured to provide data to the electronic device 50 upon communication with the electronic device for unlocking the lock mechanism.

The electronic device 50 is configured to at least unlock the electronic lock 12 from the locked configuration. The electronic device 50 is not required to place the electronic lock 12 into the locked configuration after the drawer 15 is moved to the closed position. Thus, a sales associate is unable to leave an electronic lock 12 in an unlocked state. In some embodiments of the invention, a successful activation of the electronic device 50 occurs, for example, when a security code of the electronic device, for example, a programmable electronic key, matches a security code assigned to the electronic lock 12. Therefore, only when the codes match will the electronic device 50 transfer power to the electronic lock 12.

Regardless, the electronic device 50 may be positioned proximate to, near, or adjacent to, the drawer 15 for activating the electronic lock 12. The electronic device 50 may be activated simply by being placed in proximity to the electronic lock 12 to thereby initiate communication between the electronic device and the electronic lock. For example, the electronic device 50 may be configured to communicate with the electronic lock 12 within a particular distance, such as, for example, within about 5 inches, within about 4 inches, within about 3 inches, within about 2 inches, or within about 1 inch.

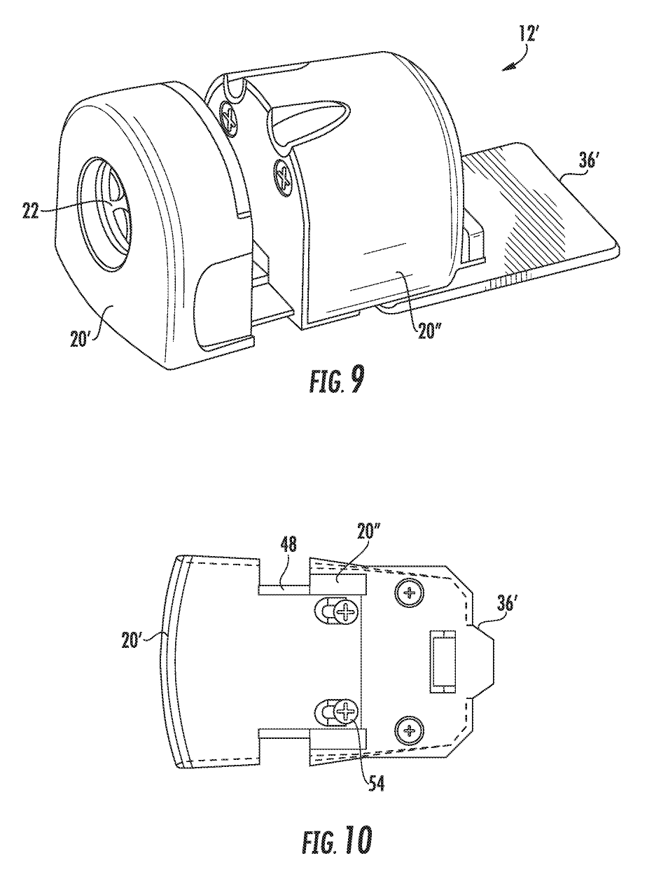

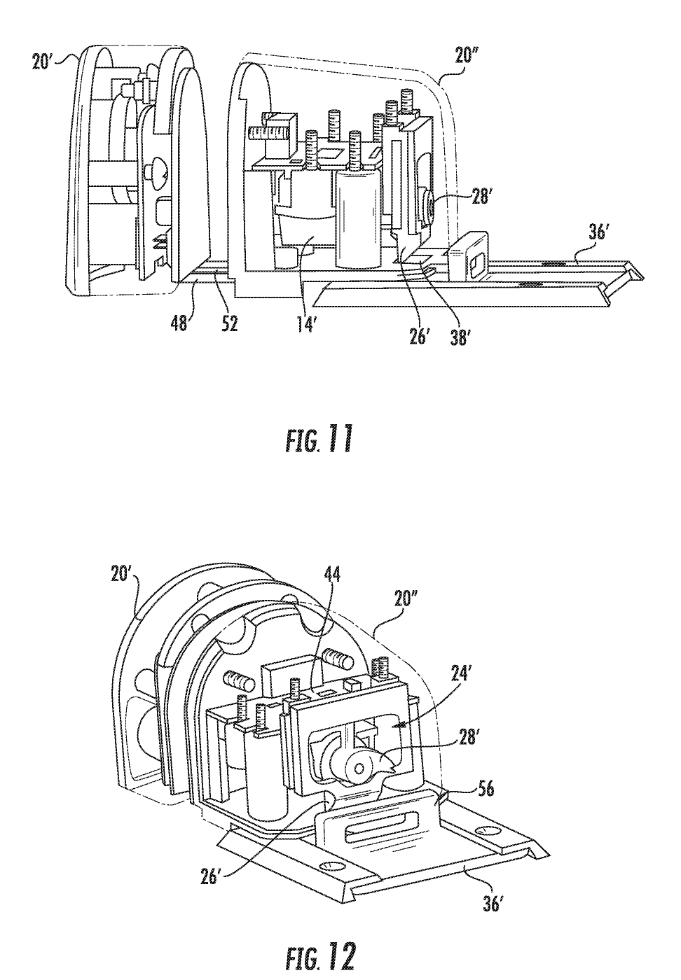

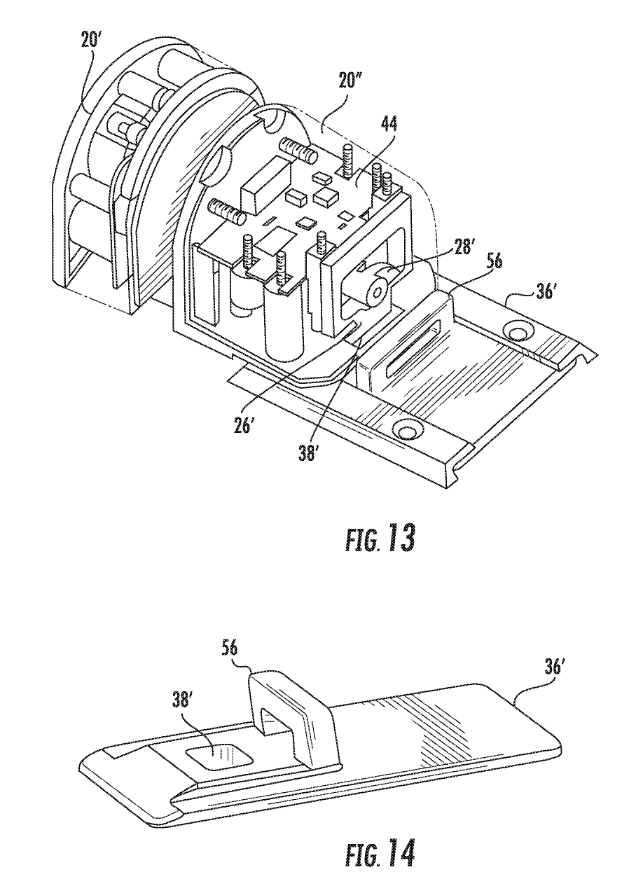

FIGS. 8-13 illustrate another embodiment of an electronic lock 12′. In this embodiment, the electronic lock 12′ may include a front housing 20′ configured to engage a front surface of the door 18″ and a rear housing 20″ configured to engage a rear surface of the door. In this way, the portion of the electronic lock 12′ disposed on the outer surface of the door 18″ may be of a significantly smaller profile than the electronic lock 12. In this example, the front housing 20′ includes a transfer port 22 for communicating with an electronic device 50, as discussed above, while the rear housing 20″ includes a lock mechanism 24′. In some embodiments, the front housing 20′ and rear housing 20″ may be separate components and attached together or the front and rear housing may be integrally formed. The front housing 20′ and the rear housing 20″ may be mechanically and/or electronically coupled to one another. In one embodiment, a connector 48 may extend between the front housing 20′ and the rear housing 20″ for coupling the front and rear housing together. The connector 48 may be integrally formed with the front housing 20′ or the rear housing 20″ or could be separately attached. The connector 48 may be configured to couple the front housing 20′ and the rear housing 20″ as well as extend underneath the door 18″ (see, e.g., FIG. 15). The length of the connector 48 may be approximately the width of the door 18″, although the connector may be adjustable in some embodiments. In this regard, the front housing 20′ and the rear housing 20″ may be connected in a way that allows adjustment therebetween, such as via a dovetail or similar sliding engagement that allows the front and rear housing to be moved relative to one another. For example, FIG. 10 shows that the front housing 20′ may include the connector 48, and rear housing 20″ may be configured to receive the connector in a sliding engagement and secured via fasteners. Moreover, the front housing 20′ and the rear housing 20″ may be electronically connected via one or more conductors 52. For instance, the one or more conductors 52 may be a ribbon cable or flexible circuit in some cases that is configured to electrically connect the front housing 20 to the rear housing 20″, for example, to electrically connect a printed circuit board in the front housing with a printed circuit board in the rear housing. Thus, power and/or data may be configured to be transferred between the front housing 20′ and the rear housing 20″ via the one or more conductors 52. The one or more conductors 52 may be attached to an outer surface of the connector 48 or could be integrated therewith, and a portion of the conductors may extend within the front housing 20′ and/or the rear housing 20″.

Similar to the embodiments discussed above, the electronic lock 12′ may include a lock mechanism 24′ configured to move between locked and unlocked configurations. In the illustrated embodiment, the lock mechanism 24′ is a mechanical lock including one or more actuators 26′ that are configured to move between an engaged position and a disengaged position. The actuator 26′ may be configured to extend and retract between the engaged and disengaged positions. In some cases, the actuator 26′ may be biased towards a locked state. FIGS. 11-13 show an embodiment of a lock mechanism 24′ whereby a motor 14′ is configured to rotate a camming mechanism 28′. In some cases, rotation of the camming mechanism 28′ results in actuation of the actuator 26′. For example, the motor 14′ may be configured to rotate the camming mechanism 28′ to thereby move the actuator 26′ from a locked state to an unlocked state. Upon expiration of a predetermined period of time, the motor 14′ may be configured to rotate the camming mechanism 28′ to allow the actuator 26′ to return to the locked state.

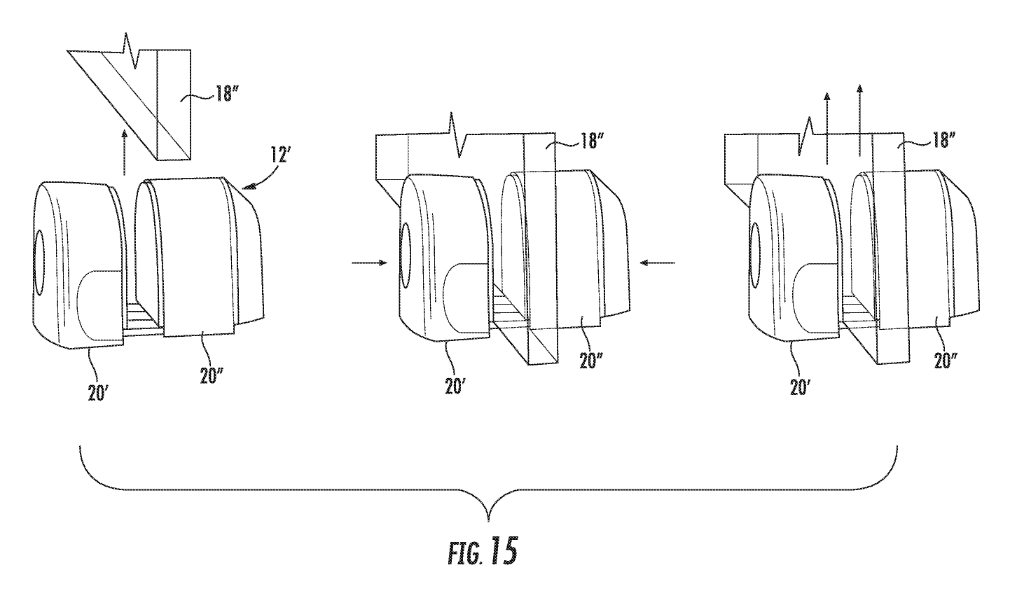

FIG. 14 illustrates an embodiment of a strike plate 36′. The strike plate 36′ may include one or more openings 38′ configured to receive the actuator 26′ in a locked state. Similar to the embodiments discussed above, the strike plate 36′ is configured to be secured directly to an outer surface of the merchandise fixture 18 without the need for machining, milling, or otherwise removing a portion of the outer surface of the merchandise fixture to receive the strike plate. Thus, the strike plate 36′ may be secured directly to an outer surface of the merchandise fixture, and in some cases, directly to the fixed support structure 18′. As also shown in FIG. 14, the strike plate 36′ may include at least one blocking member 56 for engagement with the rear housing 20″. In this regard, the blocking member 56 may be configured to receive or otherwise engage a portion of the rear housing 20″ to limit or prevent the door 18″ from being lifted to thereby limit or prevent the lock mechanism 24′ from disengaging the strike plate 26′. For instance, without the use of the blocking member 56, lifting of the door 18″ may allow the actuator 26′ to disengage the opening 38′ for defeating the lock mechanism 24′. It is understood that one or more blocking members 56 may be employed at various locations on the strike plate 36′. For example, the illustrated embodiment of FIG. 14 shows a single blocking member 56, but a plurality of blocking members could be used, such as a pair of blocking members at an end of the strike plate located adjacent to the rear housing 20″ in a locked state. In some cases, blocking members 56 could be located at the end of the strike plate 36′ as well as additional blocking member(s) spaced from the end of the strike plate such as shown in FIG. 14.

FIG. 15 illustrates an example embodiment for installing the electronic lock 12′ to a door 18″. Initially, the electronic lock 12′ is positioned below a bottom surface of the door 18″ and then positioned such that the front housing 20′ is located on a front surface of the door and the rear housing 20″ is located on a rear surface of the door. The connector 48 may be positioned adjacent to the bottom surface of the door 18″. The front housing 20′ and the rear housing 20″ may be adjusted relative to one another so that each abuts a surface of the door 18″. In some instances, the front housing 20′, the rear housing 20″, and/or the connector 48 include an adhesive for being secured to the door 18″. Pressure may be applied to both the front housing 20′ and the rear housing 20″ in a direction perpendicular to the front and rear surfaces of the door 18″ in a way that secures the front and rear housing to the door. Pressure may also be applied parallel to the front and rear surfaces of the door 18″ in a way that secures the connector 48 to the bottom surface of the door. In one example, the front housing 20′ and the rear housing 20″ may each include a releasable adhesive tab, such that pulling on the tabs exposes the adhesive surfaces and thereby secures the front and rear housing to the door 18″. The adhesive tabs may be configured in a way that the tabs may be removed while the front housing 20′ and the rear housing 20″ are in a desired position on the door 18″.

Therefore, embodiments of the present invention may provide several advantages. For instance, a sales associate is not required to lock the electronic lock after being unlocked since the lock mechanism is configured to self lock automatically. Moreover, the door is able to be closed while the lock mechanism is in a locked state such that the electronic lock does not need to communicate with the electronic device in order to close the door. In addition, the electronic lock cannot be left in an unlocked state, even after communicating with an electronic device and while the door remains closed, since the lock mechanism self locks after a predetermined period of time. Unlike conventional mechanical keys that can function as a “handle” when in an unlocked state, the electronic key allows for automatic relocking even when the electronic device is no longer in communication therewith. Furthermore, the electronic lock includes “anti-picking” features that resist defeating the lock while in a locked state. The electronic lock also allows for use with different types of merchandise fixtures, and may be mounted to stationary or movable merchandise fixtures or components thereof.

The foregoing has described one or more embodiments of a merchandise security device, system and method for protecting an item of merchandise from theft. Embodiments of a merchandise security device and system have been shown and described herein for purposes of illustrating and enabling the best mode of the invention. Those of ordinary skill in the art, however, will readily understand and appreciate that numerous variations and modifications of the invention may be made without departing from the spirit and scope thereof. Accordingly, all such variations and modifications are intended to be encompassed by the appended claims.

That which is claimed is:

1. A merchandise security device for protecting an item of merchandise from theft, the merchandise security device comprising:
a lock configured to be secured to one of a movable structure or a fixed support structure; and
a strike plate configured to be secured to one of the movable structure of the fixed support structure, opposite that of the lock,
wherein the movable structure is configured to move along a path into engagement with the fixed support structure to secure the item of merchandise therein in a locked state and to move out of engagement with the fixed support structure for removal of the item of merchandise in an unlocked state,
wherein the lock is configured to engage the strike plate in the locked state and to disengage the strike plate in the unlocked state,
wherein the lock is configured to engage the strike plate along the same path as the movable structure.

2. The merchandise security device of claim 1, wherein the lock comprises an actuator configured to engage the strike plate in the locked state and to disengage the strike plate in the unlocked state.

3. The merchandise security device of claim 2, wherein the actuator is configured to move linearly between the locked state and the unlocked state.

4. The merchandise security device of claim 2, wherein the actuator is configured to pivot between the locked state and the unlocked state.

5. The merchandise security device of claim 2, wherein the actuator is biased towards the locked state.

6. The merchandise security device of claim 2, wherein the actuator comprises a pair of actuators configured to engage the strike plate.

7. The merchandise security device of claim 1, wherein the lock is an electronic lock.

8. The merchandise security device of claim 1, wherein the path is arcuate.

9. The merchandise security device of claim 1, wherein the lock is configured to be secured to a movable structure, and wherein the strike plate is configured to be secured to a fixed support structure.

10. The merchandise security device of claim 1, wherein the strike plate comprises at least one blocking member configured to engage the lock in the locked state, and wherein the blocking member is configured to prevent lifting of the movable structure relative to the fixed support structure in the locked state.

11. The merchandise security device of claim 1, wherein the strike plate is configured to be secured to an outer surface of one of the movable structure or the fixed support structure without removing any portion of the outer surface for receiving the strike plate.

12. The merchandise security device of claim 1, wherein lock comprises a front housing and a rear housing, and wherein the front housing is configured to be secured to a front surface of the movable structure or the fixed support structure and the rear housing is configured to be secured to a rear surface of the movable structure or the fixed support structure.

13. The merchandise security device of claim 12, wherein the front housing and the rear housing are separated by a connector, and wherein the length of the connector is adjustable.

14. The merchandise security device of claim 12, wherein the front housing and the rear housing are electrically connected via one or more conductors.

15. The merchandise security device of claim 12, wherein the rear housing comprises a lock mechanism.

16. The merchandise security device of claim 16, wherein the movable structure is a glass door configured to pivot relative to the fixed support structure.

17. The merchandise security device of claim 17, wherein each of the movable structure and the fixed support structure is glass.

18. A method for protecting merchandise from theft, the method comprising:
securing a strike plate to one of a movable structure or a fixed support structure, the movable structure configured to move along a path into engagement with the fixed support structure to secure an item of merchandise therein in a locked state and to move out of engagement with the fixed support structure for removal of the item of merchandise in an unlocked state; and
attaching a lock to one of the movable structure of the fixed support structure, opposite that of the strike plate, the lock configured to engage the strike plate in a locked state and to disengage the strike plate in an unlocked state, the lock configured to engage the strike plate along the same path as the movable structure.

19. The method of claim 18, wherein securing comprises securing the strike plate to the outer surface of the merchandise fixture without removing any portion of the outer surface for receiving the strike plate

20. The method of claim 19, wherein securing comprises securing the strike plate to the outer surface of the merchandise fixture without machining or milling the outer surface.

21. The method of claim 18, further comprising actuating the lock to move the lock from the locked state to the unlocked state.

22. The method of claim 18, wherein securing comprising securing the strike plate to a fixed support structure of the merchandise fixture.

23. The method of claim 22, wherein attaching comprises attaching the lock to a movable structure of the merchandise fixture.

24. The method of claim 23, wherein attaching comprises attaching a lock to a front surface of the movable structure and a rear surface of the movable structure.

25. A merchandise security device for protecting an item of merchandise from theft, the merchandise security device comprising:
a lock configured to be secured to one of a movable structure or a fixed support structure; and
a strike plate configured to be secured to an outer surface of one of the movable structure or the fixed support structure, opposite that of the lock, without removing any portion of the outer surface for receiving the strike plate,
wherein the lock is configured to engage the strike plate in the locked state and to disengage the strike plate in the unlocked state.
